(19) United States
(12) Patent Application Publication
(10) Pub. No.: US 2006/0227492 A1
(43) Pub. Date: Oct. 12, 2006

(54) Food storage container

(76) Inventor: Pei Wen Tai, Taipei (TW)

Correspondence Address: PRO-TECTOR INTERNATIONAL SERVICES, 20775 NORADA CT., SARATOGA, CA, 95070, US

(21) Appl. No.: 11/102,366

(22) Filed: Apr. 7, 2005

(51) Int. Cl. H01T 23/00

(52) U.S. Cl. 361/230

(57) ABSTRACT

Disclosed is a food storage container, which includes a container body, a top cover hinged to the container body, a lock for locking the top cover to the container body, a vacuum pump for pumping air out of the container body, an ozone generator for supplying ozone to the inside chamber of the container body, a relief valve installed in the top cover for controlling discharge of gas out of the container body, and a time-control circuit board for controlling the operation of the vacuum pump and the ozone generator.

### BACKGROUND OF THE INVENTION

1. Field of the Invention

The present invention relates generally to a storage container for keeping foods and more particularly, to a food storage container, which supplies ozone to keep storage food fresh for long.

2. Description of the Related Art

When brads, cakes, or other foods are unpacked after purchase, they are exposed to air and become deteriorated soon. There are commercially available food storage boxes for keeping foods in fresh. However, these food storage boxes are not convenient to use. Further, these food storage boxes cannot keep storages foods fresh for a long time.

### SUMMARY OF THE INVENTION

The present invention has been accomplished under the circumstances in view. It is the main object of the present invention to provide a food storage container, which is easy to use. It is another object of the present invention to provide a food storage container, which keeps storage foods fresh for long. According to one aspect of the present invention, the food storage container comprises container body, the container body defining therein a chamber; a top cover hinged to the container body and adapted to close the chamber in an airtight status, the top cover having a top recess and an air outlet in the top recess in air communication with the chamber; locking structure adapted to lock the top cover to the container body; a relief valve adapted to control the passage of the air outlet; a vacuum pump installed in the container body outside the chamber and adapted to pump air out of the chamber; an ozone generator installed in the container body outside the chamber and adapted to generate ozone and to supply generated ozone to the chamber; an airbag type sensor installed in the container body and adapted to detect the pressure of gas in the chamber; and a micro switch installed in the container body and connected to the airbag type sensor and adapted to control the operation of the vacuum pump and the ozone generator subject to the status of the pressure of gas in the chamber detected by the airbag type sensor.

According to another aspect of the present invention, the relief valve comprise a locating block fixedly fastened to the top recess of the top cover, the locating block having a button hole, a button inserted through the button hole and pivotally connected to the locating block, a rubber stopper fixedly fastened to one end of the button and adapted to stop the air outlet, and a spring member connected between the top recess of the top cover and one end of the button remote from the rubber stopper and adapted to support the button in such a position where the rubber stopper is stopped at the air outlet.

According to still another aspect of the present invention, the locking structure comprises a retaining rib provided at the container body, a sliding rail provided at the top cover corresponding to the retaining rib, and a locking member coupled to the top cover for securing the retaining rob to the sliding rail to lock the top cover to the container body. The locking member comprises a track coupled to the sliding rail, a hook for hooking the retaining rib, a spring member mounted on the inside, and a knob supported on the spring member After coupling of the track to the sliding rail, the hook is hooked on the retaining rib to lock the top cover to the container body. When pressed the knob with the finger, track is disengaged from the retaining rib, thereby unlocking the top cover.

### BRIEF DESCRIPTION OF THE DRAWINGS

FIG. 1 is a perspective view of a food storage container according to the present invention.

FIG. 2 is an exploded view of the food storage container according to the present invention.

FIG. 3 is an exploded view in an enlarged scale of a part of the present invention, showing the structure of the relief valve.

FIG. 4 is a sectional assembly view of FIG. 3.

FIG. 5 is an exploded view in an enlarged scale of a part of the present invention, showing the structure of the locking member.

FIG. 6 is similar to FIG. 4 but showing the button biased, the rubber stopper disengaged from the air outlet.

FIG. 7 is a schematic drawing showing the airbag type sensor compressed, the switching lever of the micro switch in the off position.

FIG. 8 corresponds to FIG. 7 but showing the switching lever of the micro switch in the on position.

### DETAILED DESCRIPTION OF THE INVENTION

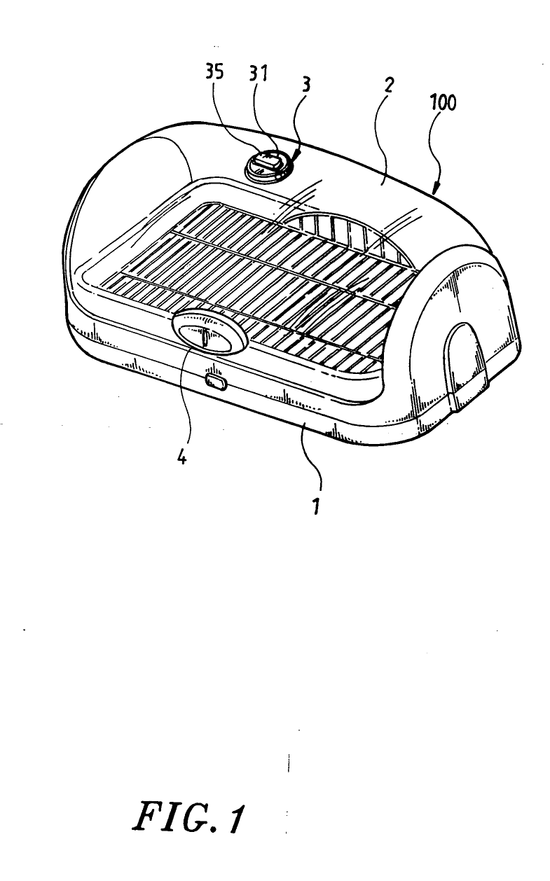

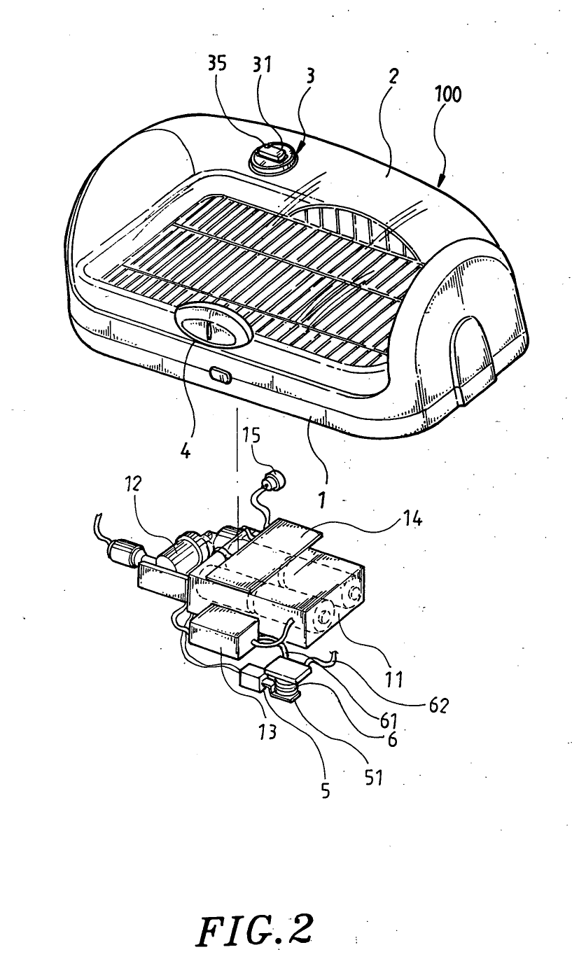

Referring to FIGS. 1 and 2, a food storage container 100 in accordance with the present invention is shown comprising a container body 1, a top cover 2 hinged to the container body 1 and adapted to close/open the container body 1, a battery pack 11 provided at the bottom side of the container r body 1, an ozone generator 13 provided at the bottom side of the container body 1 and adapted to generate ozone and to supply generated ozone to the inside space of the a vacuum pump 12 provided at the bottom side of the container body 1 and adapted to pump air out of the container body 1, a time-control circuit board 14 provided at the bottom side of the container body 1 and adapted to control the operation of the vacuum pump 12 and the ozone generator 13, an on/off switch 15 electrically connected to the time-control circuit board 14, an airbag type sensor 6 provided at the bottom side of the container body 1 and respectively connected to the ozone generator 13 and the inside space of the container body 1 by air tubes 61; 62, and a micro switch 5 provided at the bottom side of the container body 1. The micro switch 5 has a switching lever 51 pressed on the airbag type sensor 6.

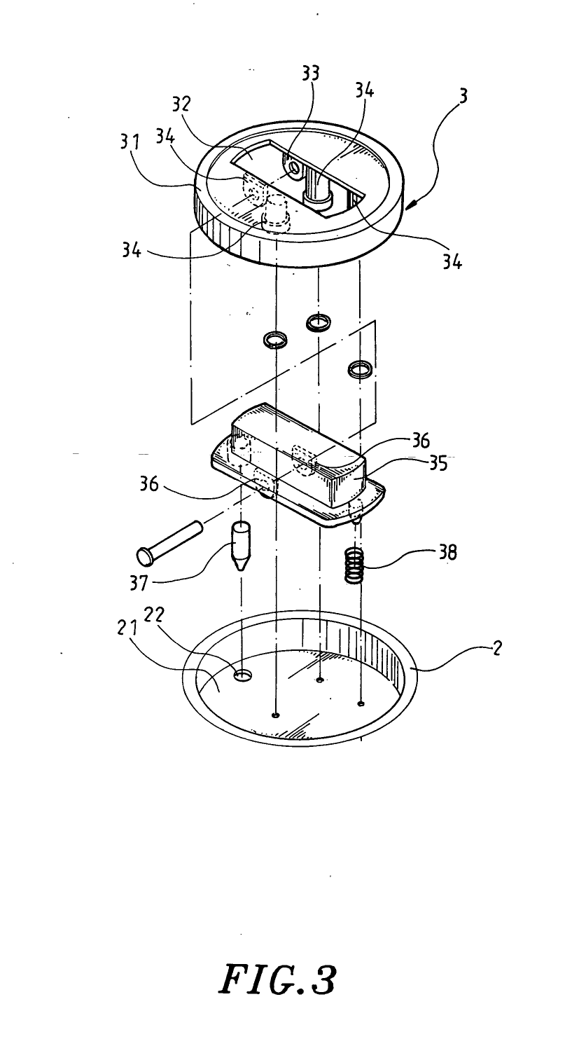

Referring to FIGS. 3, 4 and 6, the top cover 2 has a top recess 21 and an air outlet 22 in the top recess 21. A relief valve 3 is installed in the top recess 21 of the top cover 2. The relief valve 3 comprises a locating block 31, which has a button hole 32, a plurality of bottom mounting rods 34 respectively fixedly fastened to the top recess 21 of the top cover 2, and two bottom lugs 33 symmetrically disposed at two sides of the button hole 32, a button 35, which is inserted through the button hole 32 of the locating block 31 and has two button lugs 36 symmetrically disposed on the middle at two sides and respectively pivoted to the bottom lugs 33 of the locating block 31, a spring member 38 connected between the top recess 21 of the top cover 2 and one end of the button 35, and a rubber stopper 37 fastened to the other end of the button 35 and adapted to close the air outlet 37. Normally, the spring member 38 supports the button 35 in such a position that the rubber stopper 37 seals the air outlet 22. When the user pressed one end of the button 35 against the spring member 38, the button 35 is biased to lift the rubber stopper 37 from the air outlet 22, thereby opening the air outlet 22.

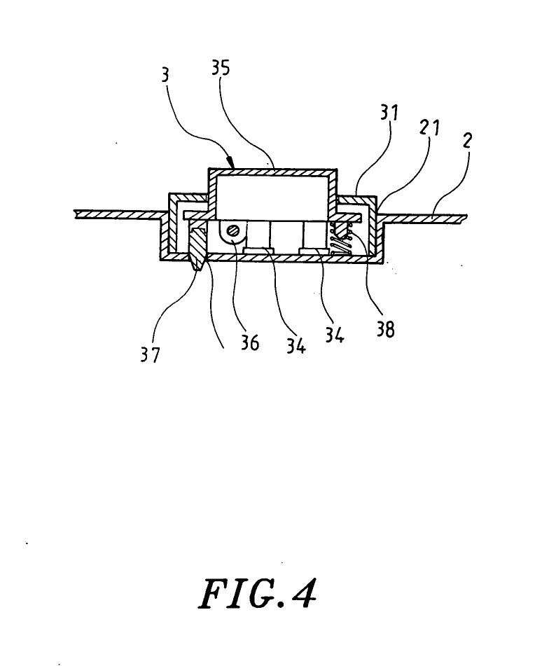

Referring to FIG. 5 and FIG. 1 again, the container body 1 has a retaining rib 16 disposed at the front side along the top rim thereof. The top cover 2 has a sliding rail 23 disposed at the front side corresponding to the retaining rib 16 of the container body 1. A locking member 4 is coupled to the top cover 2 for securing the retaining rob 16 to the sliding rail 23 to lock the top cover 2 to the container body 1. The locking member 4 comprises a track 41 coupled to the sliding rail 23, a hook 42 for hooking the retaining rib 16, a spring member 44 mounted on the inside, and a knob 43 supported on the spring member 44. After coupling of the track 41 to the sliding rail 23, the hook 42 is hooked on the retaining rib 16 to lock the top cover 2 to the container body 1. When pressed the knob 43 with the finger, track 41 is disengaged from the retaining rib 16, thereby unlocking the top cover 2.

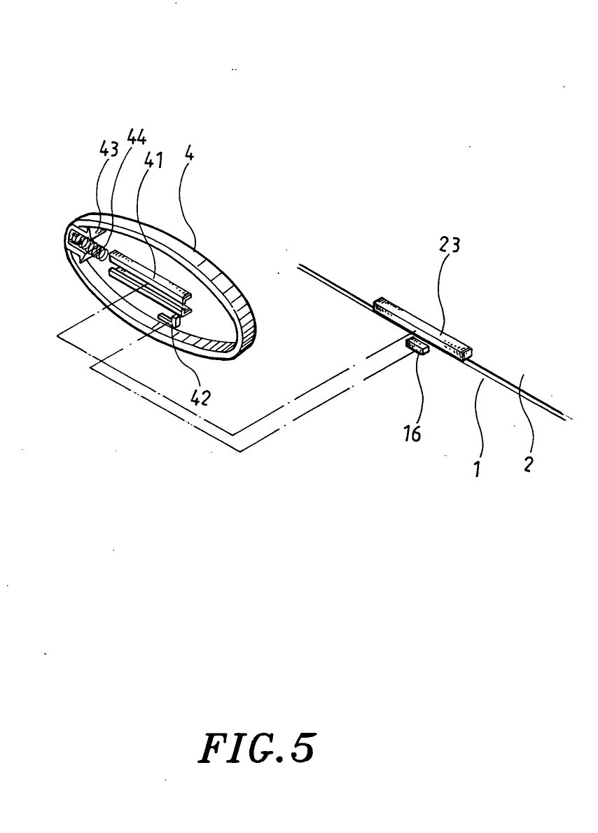

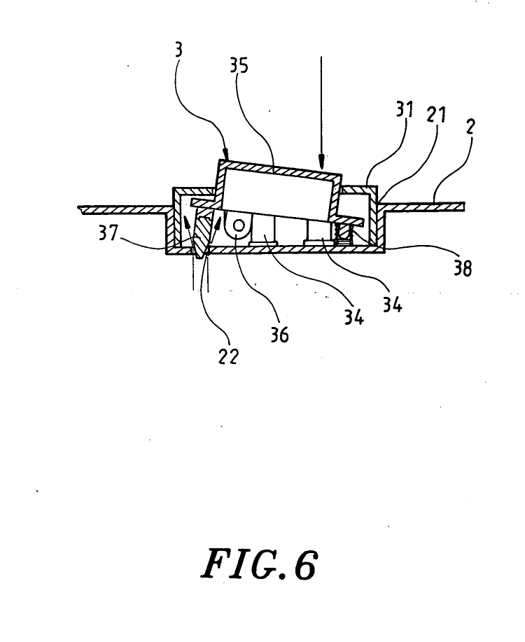

Referring to FIGS. 2 and 6 again, when food is stored in the container body 1, the top cover 2 is closed and locked by the locking member 4, and then the on-off switch 15 is switched on, causing the time-control circuit board 14 to drive the vacuum pump 12 to pump air out of the container body 1 and then to drive the ozone generator 13 to generate ozone and to supply ozone to the inside space of the container body 1. When wishing to pick up storage food for service, switch off the on-off switch 15, then press the button 35 to disengage the rubber stopper 37 from the air outlet 22, for enabling gas to escape out of the container body 1 to the outside of the food storage container 100 through the air outlet 22. The user can then open the top cover 2 and take storage food out of the container body 1.

Referring to FIGS. 7 and 8 and FIGS. 1 and 2 again, normally, the airbag type sensor 6 is at a compressed status to lower the switching lever 51, and the micro switch 5 is off. When gas passes to the inside of the container body 1, the airbag type sensor 6 is inflated to lift the switching lever 51 of the micro switch 5, thereby causing the micro switch 5 to switch on the time-control circuit board 14, and therefore the time-control circuit board 14 drives the vacuum pump 12 to pump air out of the container body 1 and then drives the ozone generator 13 to generate ozone and to supply ozone to the inside space of the container body 1.

A prototype of food storage container has been constructed with the features of FIGS. 1˜8. The food storage container functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A food storage container comprising:
a container body, said container body defining therein a chamber;
a top cover hinged to said container body and adapted to close said chamber in an airtight status, said top cover having a top recess and an air outlet in said top recess in air communication with said chamber;
lock means adapted to lock said top cover to said container body;
a relief valve adapted to control the passage of said air outlet, said relief valve comprising a locating block fixedly fastened to said top recess of said top cover, said locating block having a button hole, a button inserted through said button hole and pivotally connected to said locating block, a rubber stopper fixedly fastened to one end of said button and adapted to stop said air outlet, and a spring member connected between said top recess of said top cover and one end of said button remote from said rubber stopper and adapted to support said button in such a position where said rubber stopper is stopped at said air outlet;
a vacuum pump installed in said container body outside said chamber and adapted to pump air out of said chamber;
an ozone generator installed in said container body outside said chamber and adapted to generate ozone and to supply generated ozone to said chamber;
an airbag type sensor installed in said container body and adapted to detect the pressure of gas in said chamber; and
a micro switch installed in said container body and connected to said airbag type sensor and adapted to control the operation of said vacuum pump and said ozone generator subject to the status of the pressure of gas in said chamber detected by said airbag type sensor.
